(19) United States
(12) Patent Application Publication
(10) Pub. No.: US 2002/0087966 A1
(43) Pub. Date: Jul. 4, 2002

(54) Methods and apparatuses for building installation software

(76) Inventors: Morris Wiginton III, Evergreen, CO (US); Eric Morgan, Arvada, CO (US)

Correspondence Address: HOLLAND & HART LLP, PO BOX 8749, 555 17TH STREET, STE 3200, DENVER, CO, 80201, US

(21) Appl. No.: 09/998,415

(22) Filed: Nov. 29, 2001

Related U.S. Application Data
(60) Provisional application No. 60/250,189, filed on Nov. 30, 2000.

(51) Int. Cl. G06F 9/445

(52) U.S. Cl. 717/174

(57) ABSTRACT

The present invention includes a Wizard Building Application, Database, and Setup Wizard Application to solicit and apply user specific information to allow the installation of software packages by the end user without a software expert to guide the installation.

The patent application claims the benefit of U.S. Provisional Patent Application Serial No. 60/250,189, filed Nov. 30, 2000, titled METHOD AND APPARATUS FOR BUILDING INSTALLATION SOFTWARE.

### FIELD OF THE INVENTION

This invention relates to software installation and, more particularly, to methods and apparatuses for building installation software and the installation software built to allow an end user to install software packages.

### BACKGROUND OF THE INVENTION

Many mid and large cap companies use general accounting software to assist in the company in managing the books. These software packages follow generally accepted accounting principles and standard accounting terms, which the end user and/or information technology person responsible for the software may not understand. Moreover, the software is often complex and beyond the ability of the end user to properly install the software. Thus, the end user employs a specially trained software installation expert to install the accounting software.

One such accounting software package is the Great Plains Solomon Select/Premier accounting software. This software contains over 50 separate modules, such as a general ledges module, an accounts receivable module, an accounts payable module, etc., that can be separately installed depending on the company's needs. While each module is typically designed as a functioning unit, many times the modules interact. Because of the complex functionalities of each module and the interaction between the modules, the actual installation of the software typically requires the services of a “software expert” to install the software, even if the company employs information technology people. On reading this disclosure, one of skill in the art will recognize that the present invention applies to many different software packages, but the examples given generally relate to accounting software because of the complex set-up and installation requirements for accounting software.

While a “software expert” is often necessary to install the software, the software expert is not an expert at the company's business model. In other words, the company not only needs a software expert to install the software, but a company expert to assist in answering particular questions relating to the company's generally accepted accounting principles, such as account names. For example, the Solomon software package requires the installation of the General Ledger module. One of the critical features of the General Ledger module is the use of accounts and subaccounts. While the software expert knows the need for the accounts and subaccounts, the company expert would be the individual with either the knowledge relating to the account and subaccounts, be it account names, account numbers, or even the number of accounts. Further, if the company's accounting protocols use different terminology then the accounting software, the company expert would be able to relate the required information with the actual information.

The exchange of information between the software expert and the company expert provides a place for a multitude of errors to occur. For example, the company expert may provide incorrect account information to the software expert. The software expert would use this incorrect information during the General Ledger setup, which could cause the entire software package installation to be incorrect, delayed, or even lost. Moreover, the software expert could interpret information incorrectly or ask the wrong questions leading to additional errors in the installation.

Thus, it would be desirable to provide installation software for software packages. Unfortunately, most software installation programs (a.k.a. “wizards”) are designed to install one particular software package with various options for configurations, often including a default setting that requires minimal input from the end user. More complex software generally requires complex wizard setups. Therefore, it would also be desirable to provide a software package that would aid in the development of the wizard.

### SUMMARY OF THE INVENTION

The foregoing and other features, utilities and advantages of the invention will be apparent from the following more particular description of a preferred embodiment of the invention as illustrated in the accompanying drawings.

To attain the advantages and in accordance with the purpose of the invention, as embodimed and broadly described herein, a method for enabling the development of installation software includes generating question definition screens and having a software expert enter questions o solicit information from a user. Part of the question entering includes identifying a question answer type and jumps to next questions based on the answers to obtain information from the user. When the question setup is complete, the questions can be stored as part of an executable file to be used by a Wizard to prompt a user for information.

Moreover, apparatuses consistent with the present invention comprise memory to store executable files, routines, objects, etc. that provide instructions processed by a processor that displays question definition screens on a monitor. An input device is used to allow a software expert to input questions designed to solicit information from a user relating to the question A compiler (which is typically part of the processor) compiles the questions and saves the compiled questions.

Still other embodiments of the present invention include computer program products having a computer usable medium with computer readable code embodied therein for processing data to develop installation software wizards. The computer readable code includes modules configured to generate question definition screens, receive input questions designed to solicit appropriate information from a user, to determine whether more information is requested by the program and linking to those questions, and saving the questions.

The present invention allow includes methods, apparatuses, and computer programs for installing software using the installation applications built above.

### BRIEF DESCRIPTION OF THE DRAWING

The above and other objects and advantages of the present invention will be apparent upon consideration of the following detailed description, taken in conjunction with the accompanying drawings, in which like reference characters refer to like parts throughout, and in which.

FIG. 1 is a functional block diagram of one possible operating environment for the present invention;

FIG. 2A to FIG. 2E are screen shots associated with one possible embodiment of the present invention;

FIG. 3 is one possible screen shot associated with one possible embodiment of the present invention;

FIG. 4 is another possible screen shot associated with one possible embodiment of the present invention;

FIG. 5 is still another possible screen shot associated with one possible embodiment of the present invention;

FIG. 6, is a flowchart relating to one possible embodiment of the Wizard Builder Application in accordance with the present invention; and

FIG. 7 is a flowchart relating to one possible Set-Up Wizard Application in accordance with the present invention.

### DETAILED DESCRIPTION

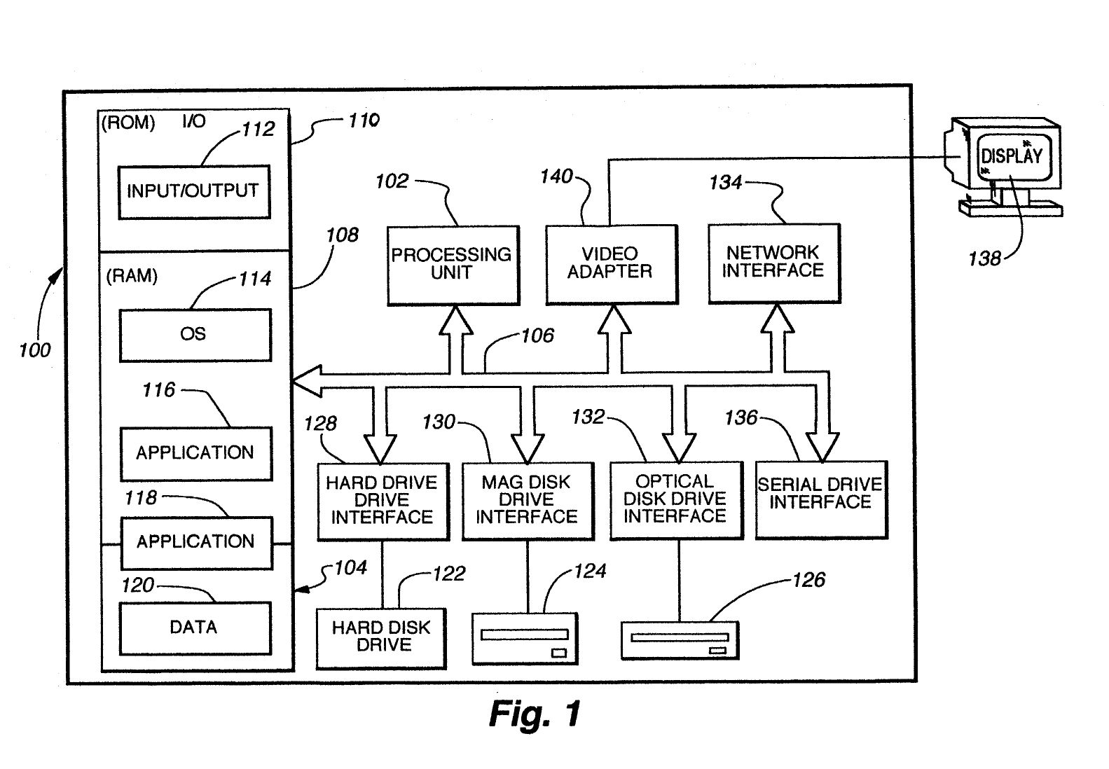

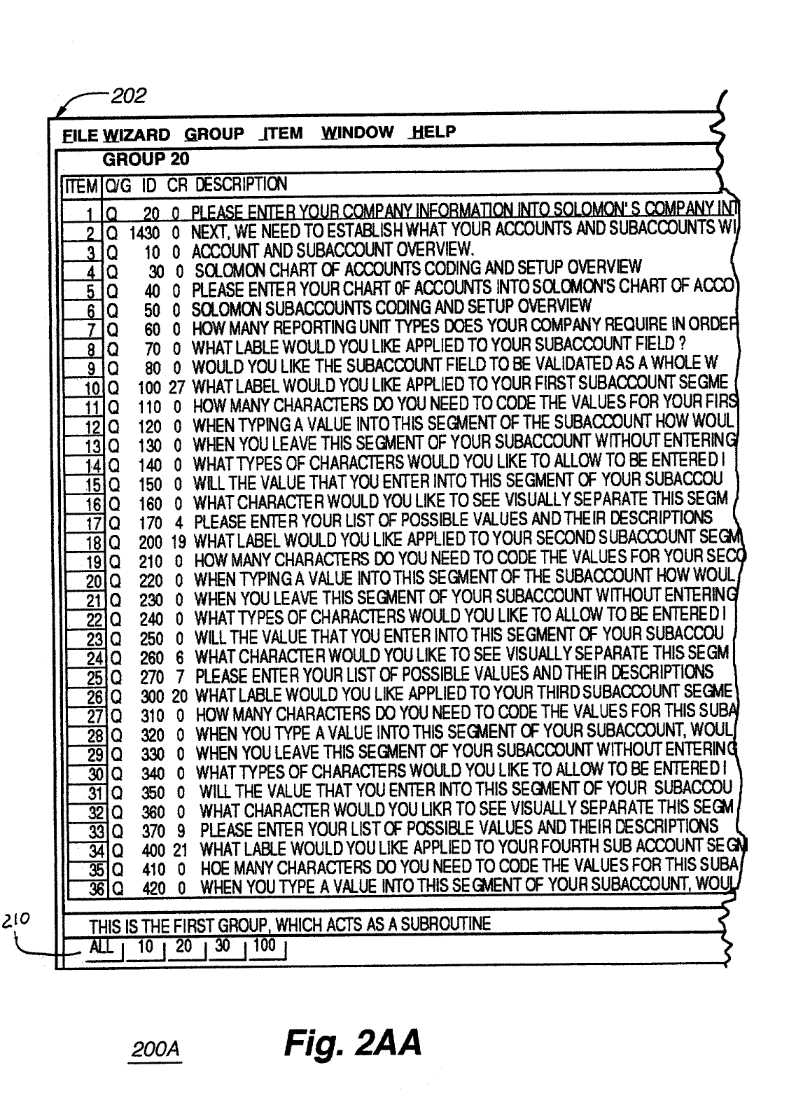

FIGS. 1-7 and the following paragraphs describe some embodiments of the present invention. Like reference characters are used wherever possible to identify like components or blocks to simplify the description of the various subcomponents described herein. More particularly, the present invention is described in relation to general accounting software packages. Further, the present invention will be described in the general context of computer-executable instructions being executed on a personal computer. Executable instructions such as, for example, program modules generally include routines, programs, objects, components, and data structures, to perform particular tasks or manipulate data. Moreover, while the present invention will be described as operating on a personal computer, one of ordinary skill in the art would appreciate that the invention could be implemented on other systems, such as, hand-held devices, multiprocessor systems, local area networks (LAN), wide are networks (WAN), microprocessor based or programmable consumer electronics, mainframe systems, or multiple server systems. Upon reading the disclosure, one of skill in the art will now recognize that alternate and equivalent embodiments of the present invention are possible and may be made without departing from the spirit and scope of the present invention.

### One Examplary Operating Environment

With reference to FIG. 1, a conventional personal computer 100 capable of implementing the present invention will be generally described. Generally, personal computer 100 includes a processing unit 102, a system memory 104, and a system bus 106. System bus 106 couples the various system components and allows data to be exchanged between the components. System bus 106 could operate on any number of conventional bus protocols. System memory 104 generally comprises both a random access memory (RAM) 108 and a read only memory (ROM) 110. ROM 110 generally stores basic operating information system such as a basic input/output system (BIOS) 112. RAM 108 often contains the basic operating system (OS) 114, application software 116 and 118, and data 120 Personal computer 100 generally includes one or more of a hard disk drive 122, a magnetic disk drive 124, or an optical disk drive 126. The drives are connected to the bus 106 via a hard disk drive interface 128, a magnetic disk drive interface 130 and an optical disk drive interface 132. Application modules and data may be stored on a disk, such as, for example, hard disk installed in the hard disk drive (not shown). Personal computer 100 also may have network connection 134 to connect to a WAN, such as the World Wide Web, and/or a serial port interface 136 to connect to peripherals, such as a mouse, keyboard, modem, or printer. Personal computer may also have USB ports or wireless components, not shown. Personal computer 100 typically has a display or monitor 138 connected to bus 106 through an appropriate interface, such as a video adapter 140. One reading this disclosure, those of skill in the art will recognize that many of the components discussed as separate units may be combined into one unit and an individually unit may be split into several different units. Further, the various functions could be contained in one personal computer or spread over several networked personal computers.

If personal computer 100 is connected to a network, typically one or more remote network server exists to manage the network resources. The network server may be another personal computer (or personal computer 100 could act as the server), a server, or other equivalent device.

In the description that follows, the present invention will be described in relation to the parts of personal computer 100. However, it should be understood that such references are not to limit the present invention to the above-described operating environment as those skilled in the art will appreciate that various operating environments may implement the present invention.

### Installation Software

Generally speaking, but not limiting, the present invention can be thought of as a Wizard Building Application, a Database, and a Setup Wizard Application (sometimes referred to simply as Wizard). The Wizard Building Application contains code and/or scripts to generate question templates to prompt software experts to generate questions that will solicit from the end user the information necessary for the Setup Wizard Application to install the software. Types of information the Wizard Building Application will solicit include names for database fields, such as an accounts receivable name or number, and other information the software to be installed needs. Software experts building the installation application supply some of the installation information, such as links between various databases, information, modules, and pathways. The Database, which could be called the Knowledge Database, stores the questions generated by the Wizard Building Application, the links the Setup Wizard Application will need to setup the software, and any help supplied by the software expert. The Wizard is an executable file that uses the questions stored in the database to solicit additional information specific to the end user and the programs being installed. Then, using the information provided by the software experts, such as database interactions and pathways, and information provided by the end user, such as the number of subaccounts and the account names and number, all of which are stored in the Database, the Setup Wizard Application installs the software package.

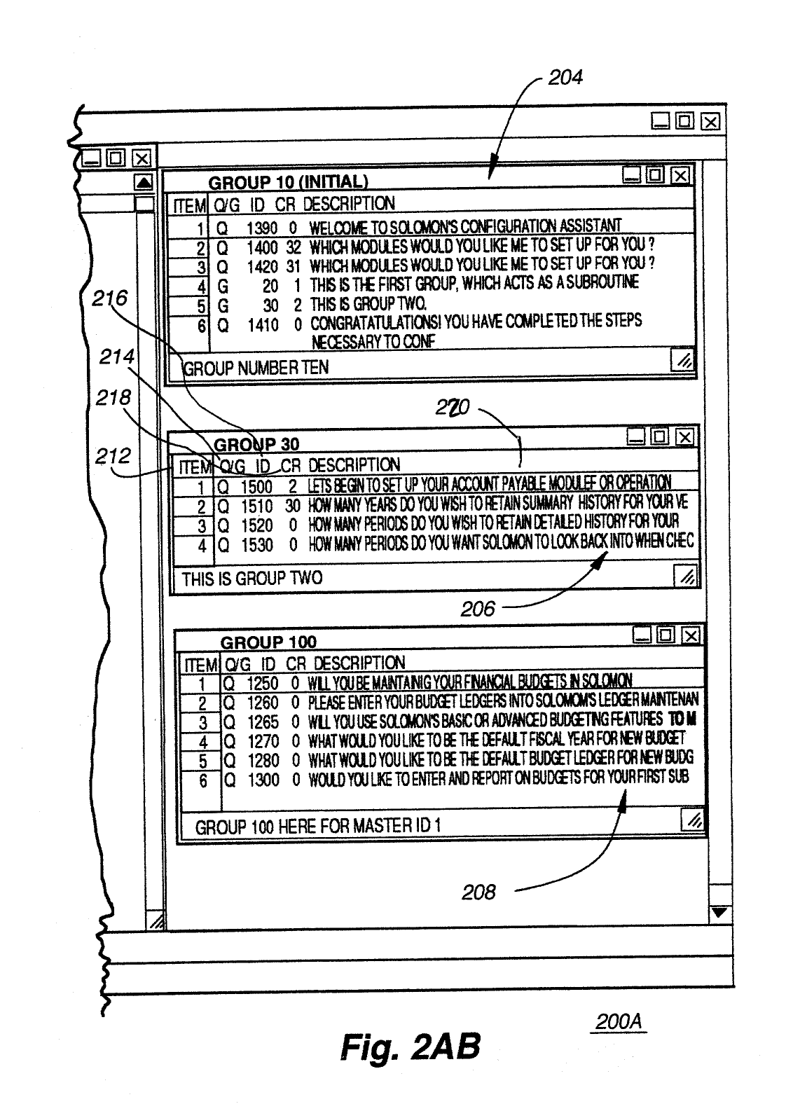

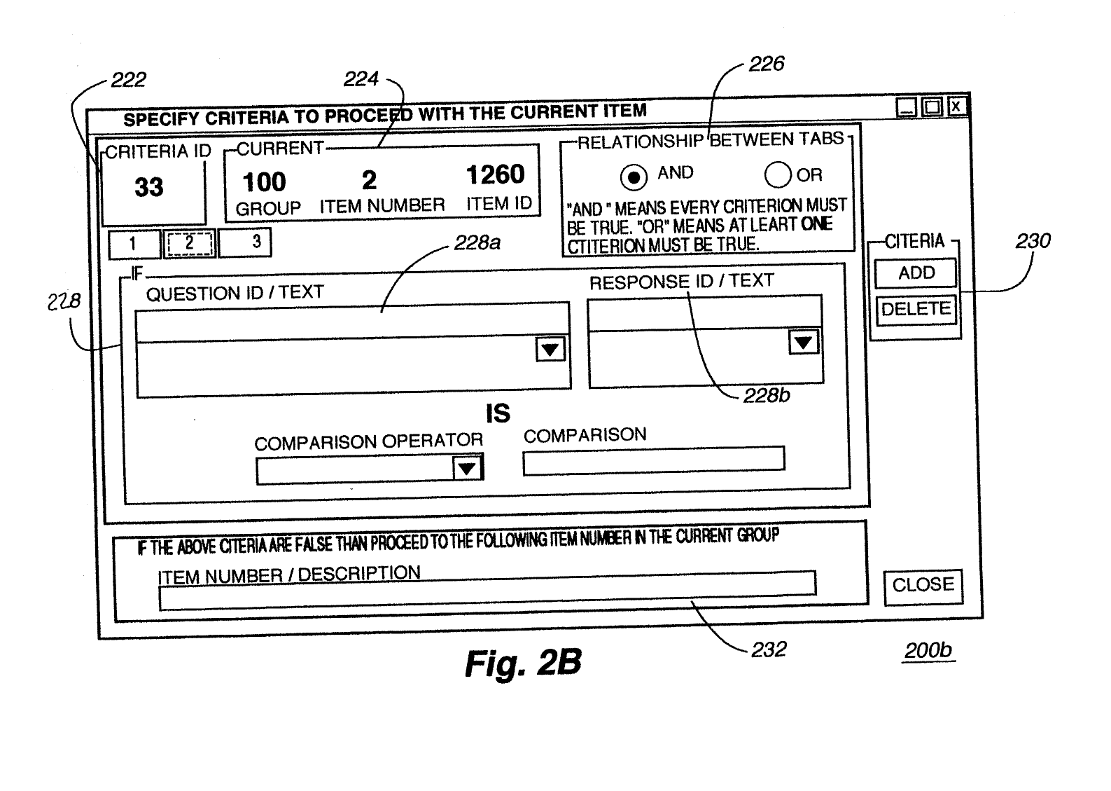

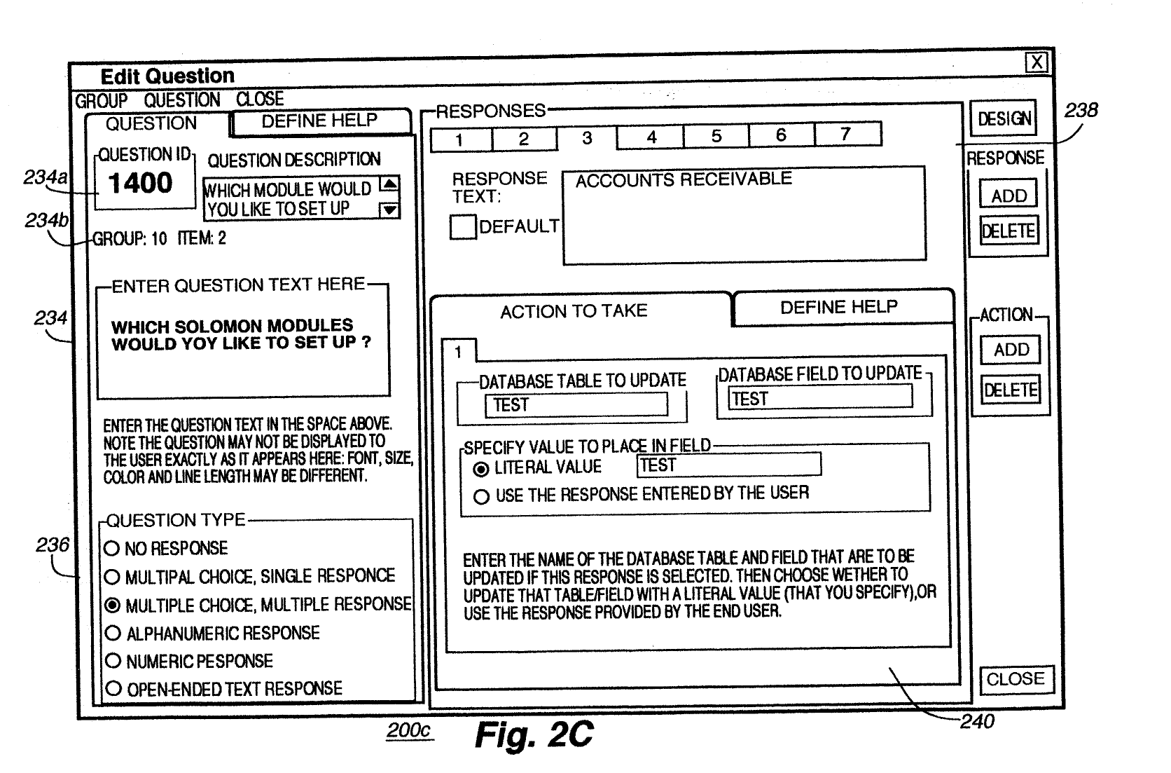

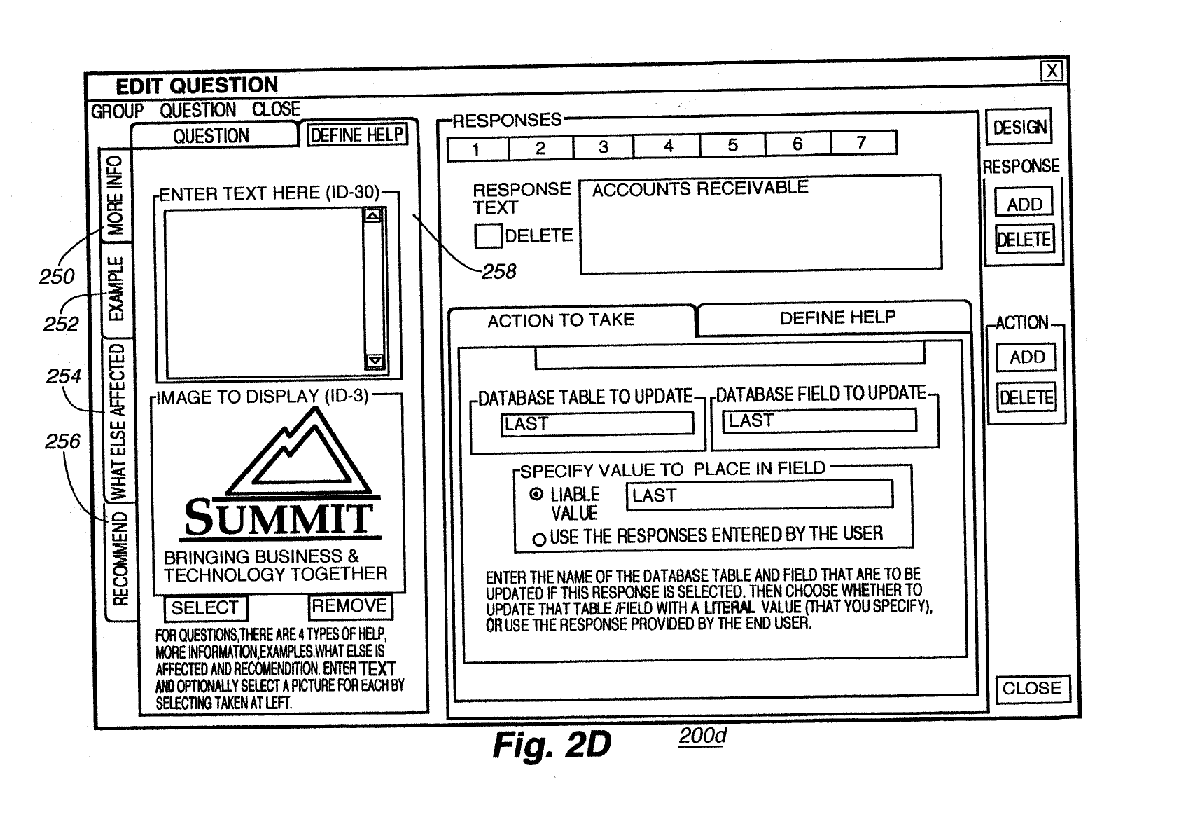

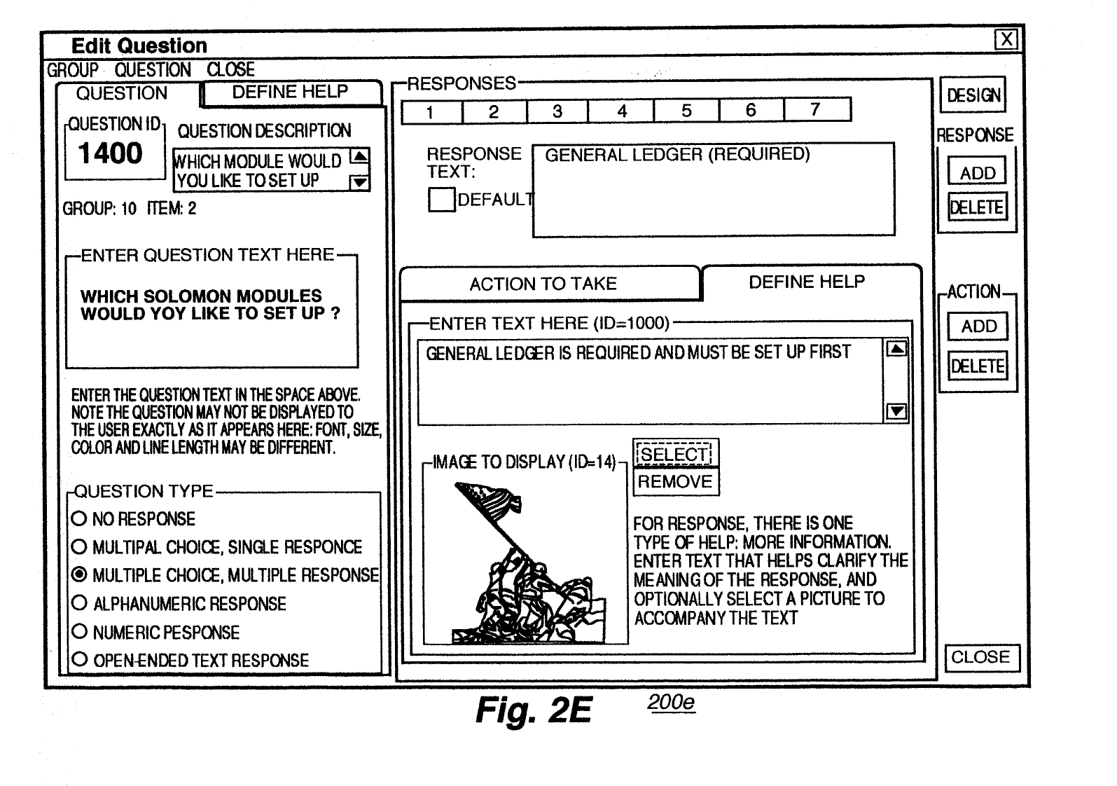

As mentioned above, the Wizard Building Application is interactive and uses question generation templates to assist the software expert in generating sufficiently detailed questions to prompt proper responses from the end user. FIGS. 2A-2E show some sample templates 200a, 200b, 200c, 200d, and 200e that could be used by the Wizard Building Application. Templates 200a to 200e demonstrate how the Wizard Building Application allows a software expert to create a slate of questions about a software product. The slate of questions typically defines the desired characteristics of a software package Once the slate of questions is developed, the Setup Wizard Application relating to that software package can be built. Using the built Wizard, an end user can install the software package.

In more detail, FIG. 2A shows a template 200a. Template 200a is a file management window containing sub windows for individual groups of questions. For example, window 202 contains group 20 questions, window 204 contains group 10 questions, window 206 contains group 30 questions, and window 208 contains group 100 questions. Each grouping of questions typically corresponds to a particular portion of the software package that may be installed. For example, for the Solomon accounting software, group 10 questions may relate to the generic installation questions to install the basic program, group 100 questions may relate to the installation of the General Ledger module, and group 20 questions may relate to the installation of the Accounts Payable module. As can be seen in FIG. 2A, template 200a may have a series of tabs 210 to identify and control access between the different question groups. While not shown, file management window could contain windows relating to separate programs, such as, windows relating to Great Plains Solomon Select/Premier, windows relating to Great Plains Dynamics/E-Enterprise, and windows relating to Sage Acuity.

Each question group is generally organized using a series of identifiers. While these identifiers can be assigned randomly, it is often easier to build the installation software manually assigning sequential identifiers. For example, window 206 contains group 30 questions. Shown in window 206 are an item identifier 212, a Q/G identifier 214, an ID identifier 216, a Cr identifier 218, and a description 220. Item identifier 212 provides a unique number for each question of the group. For example, group 30, item 2 refers to one particular question. Q/G identifier 214 identifies for the expert the type of question. For example group 20, item 3 is a question while group 10, item 4 is a group. While the particular database fields may be partially driven by the software package, the general purpose is to provide a unique identifier for question location and some limited information to allow the software expert to identify the required information.

Template 200b shows one possible question type template screen for a software expert to complete while developing the knowledge base necessary to build the installation wizard. Template 200b includes a Criteria ID field 222, a question identifier 224, a Boolean operator 226, a question field 228, which contains both the question field 228a and the response field 228b, a criteria add or delete field 230, and a jump field 232. The question field and response field may have multiple parts and the jump field may indicate different next questions (such as by group #, item # and question #) depending on the previous responses. However, different responses may jump to the same next question. As one of skill in the art would recognize on reading this disclosure, these field designations, and field are exemplary and may be eliminated, replaced, or renamed without departing from the spirit and scope of the present invention.

Template 200c shows one possible edit question screen. In particular, template 200c shows question 1400 from group 10, item 2 (FIG. 2A). Edit question template 200c has a question edit field 234, a question type field 236, a response field 238 having response tabs and response text, an action field 240. All this information combines to define pieces of information the installation wizard will need to properly define and link databases, instructions, module, executable code and reports for the software being installed As shown by FIG. 200C, question edit field 234 also contains displays relating to the file management information including a question ID display 234a, a question group and item number display 234b.

Template 200d shows one possible help definition screen associated with, for example, template 200c. While many different types of help are available, the template 200d identifies four possible helps, more information help 250, examples help 252, what is affected help 254, and recommendations help 256. As shown, each help choice would have information contained in the help field 258. Typically, the help field would contain text, but the help field could contain, by non-limiting example, text, images, video, hyperlinks, audio, or any combination thereof.

Template 200e shows question 1400 with the response 1 selected that identifies the selection of the installation of the General Ledger module for the Solomon software package.

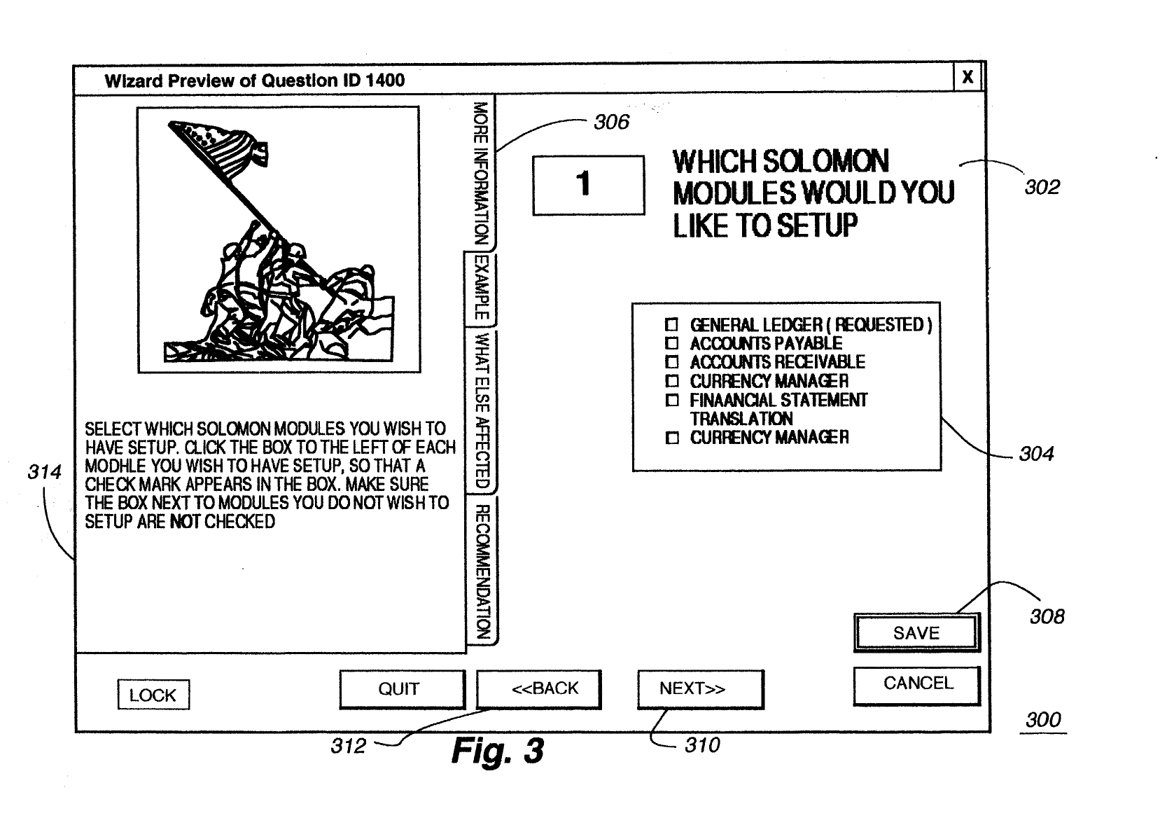

Once the necessary information associated with the above is completed, a preview 300 can be displayed. As shown in FIG. 3, a preview 300 identifies that the screen will have a question field 302, and an answer field 304, which allows selection of the possible modules to be installed as part of the Solomon software package (of which only some are shown), and a help link field 306, which has links to the appropriate help. Also shown in FIG. 3 are save tab 308, next tab 310, and back tab 312. Save tab 308 will allow the end user, when using the Setup Wizard Application to begin a session and save responses at any given point in the setup procedure. The end user could thus re-initiate an installation at the point saved. Next tab 310 is used after the answer is provided in answer field 304. Based on the answer, the software expert will provide a next question jump. The back tab 312 is used to go back to the question jumped from to, for example, change an answer As the text in the help field 314 identifies, answer field 304 is a multiple choice with multiple response question type.

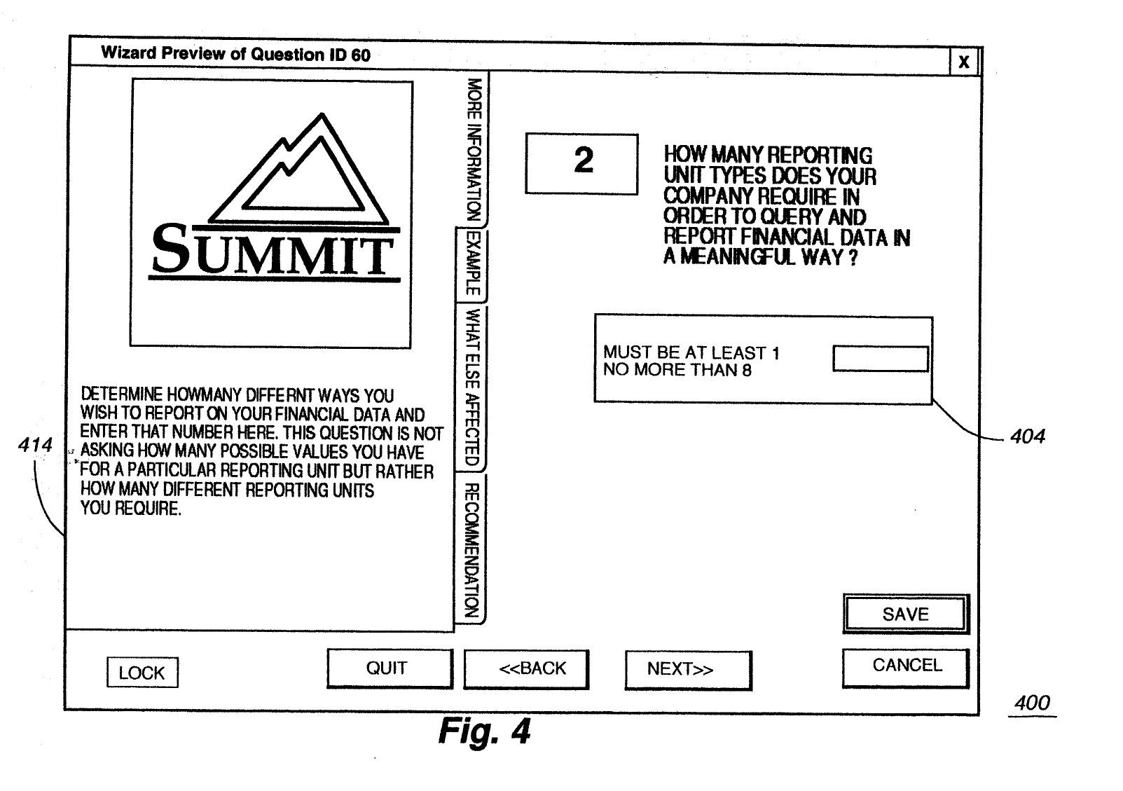

FIG. 4 shows another preview screen 400. Preview screen 400 illustrates the wizard screen an end user would view for Question ID 60 from Group 20, item 7 (FIG. 2A). Screen 400 generally contains the same information as screen 300 (FIG. 3), but as the text in help field 414 identifies, answer field 404 is a numeric answer field.

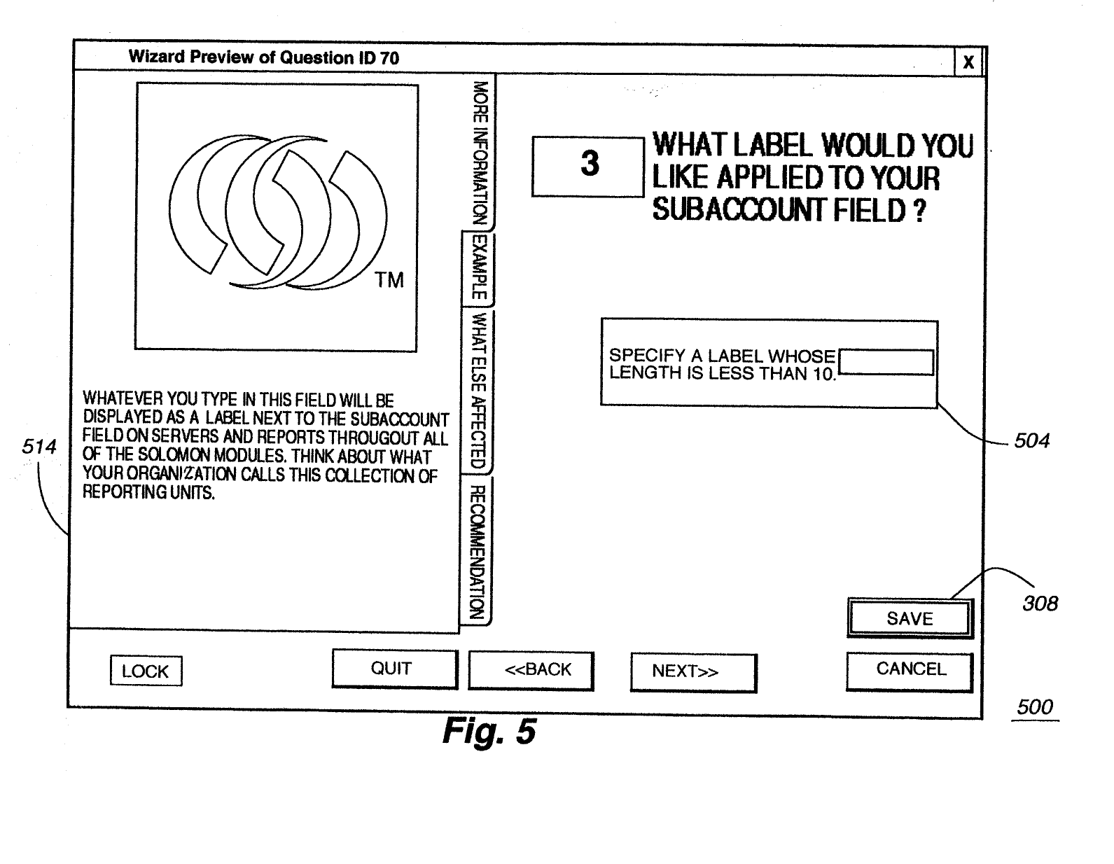

FIG. 5 shows still another preview screen 500. Screen 500 also is similar to screen 300 (FIG. 3), but as the text in help field 514 identifies, answer field 504 is an alphanumeric answer field of 10 characters. If certain keystrokes could not be used, help field 514 would generally outline non-acceptable answers as well as acceptable answers.

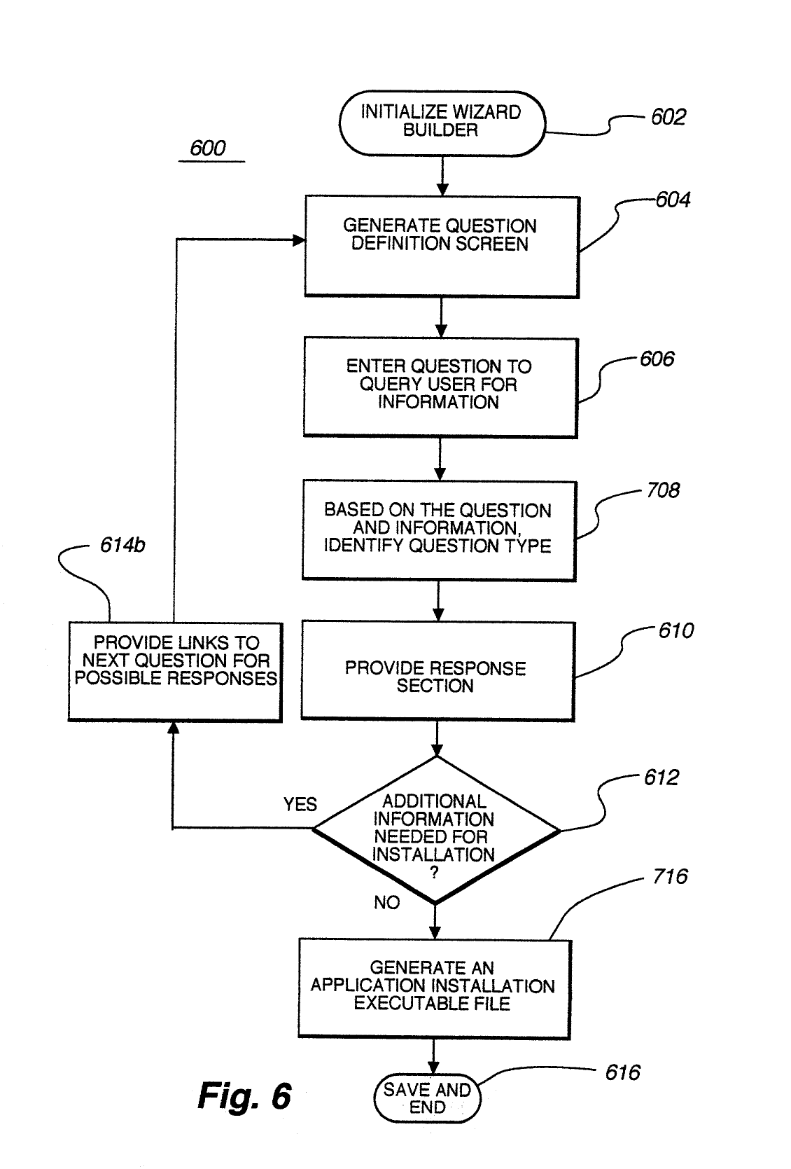

FIG. 6 is a flowchart 600 illustrating possible method associate with the present invention to build a wizard. As shown in FIG. 600, the process starts by having the processing unit 102 (FIG. 1) retrieve, initialize and begin the Wizard Building Application, step 602. The Wizard Building Application can be stored locally, as in RAM 108, on a hard disk associated with Hard Disk Drive 122, on a magnetic disk associated with magnetic disk drive 124, on an optical disk associated with optical disk drive 126, or remotely via network interface 134 or serial port interface 136. It may be beneficial to have some security protocols, such as encryption, associated with the application, especially if the application is retrieved from a remote source. Once begun, the Wizard Building Application causes the processing unit to generate a question definition screen, which is displayed to the user via video adapter 140 and display 138, step 604. The user would then enter a question to query the user for appropriate and/or necessary information relating to the installation of a particular program, step 606. The question could relate to initial setup information, such as the name and version of particular software or more user specific information such as bank account numbers. Based on the information sought by the question entered in the previous step, the user then defines the question type, step 608. Question type also could be referred to as allowable responses. Some possible question types are multiple choice one response, multiple choice multiple responses, true/false, alpha, alphanumeric, numeric, etc. Once the question and the question type are identified, the user would then provide a response section to receive the answer to the question, step 610. Once the question, question type, and possible responses are fixed, the Wizard Building Application queries the user whether additional information is necessary to install the software package, step 612. If no additional information is necessary, then the Wizard Building Application complies the information, stores the information in memory (such as memory 104), and generates an executable file, step 614a. The executable file also would be saved in memory, and the Wizard Building Application would end, step 616. If additional information is necessary, then the Wizard Building Application prompts the user to input links to the next question based on the various possible responses, step 614b. For example, if the question 10 had multiple choice answers of A, B, and C are possible, the link section would have a link to question 20 for answer A, question 30 for answer B, and question 40 for answer C. Once the link to the next question is generated, then the Wizard Building Application returns to step 604 to allow the user to begin generating the next question.

One skilled in the art will recognize that the one implementation of the present invention is a tree/branch programming structure. However, any programming structure/protocol would work. Using the tree/branch structure, for example, if the first question has responses A and B, the programmer is prompted to provide next questions for both responses A and B. If, for example response A requires response 1, 2 and 3, the programmer is prompted to enter the next step depending on the response. Once the complete path for response A is developed, the programmer is prompted to define the information if response B had been chosen. Thus, the programmer is prompted to continue questioning the end user until each identified branch terminates

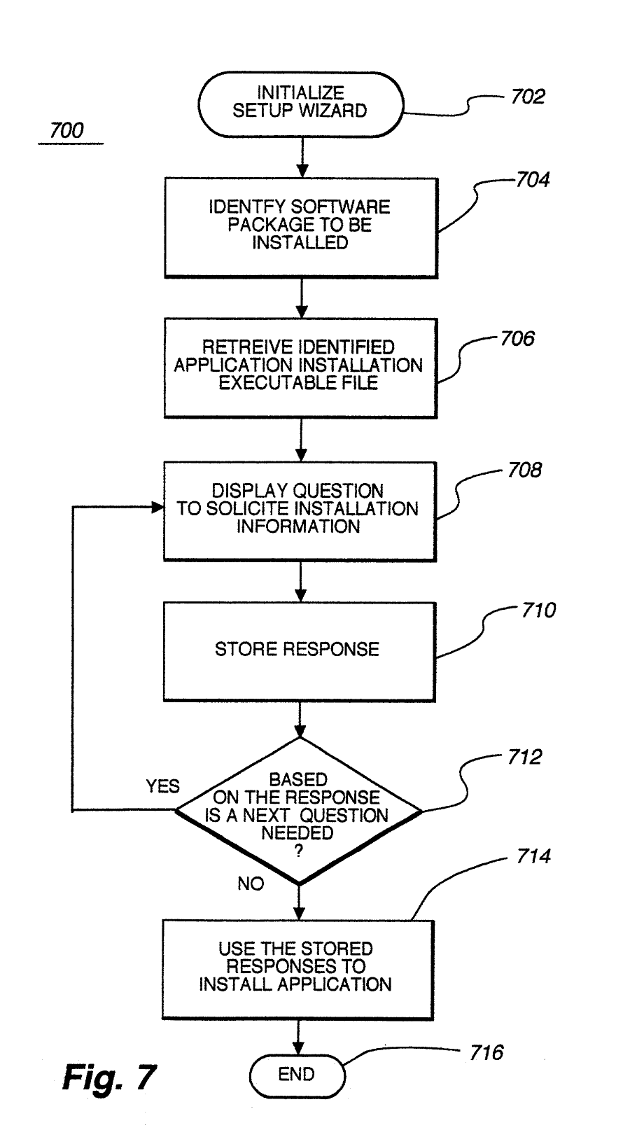

FIG. 7 is a flowchart 700 illustrating the steps associated with using the wizard built in accordance with the present invention. As shown in flowchart 700, the process begins by initializing and beginning the Setup Wizard Application, step 702. To begin, the processing unit 102 (FIG. 1) generates a query to the user, via video adapter 140 and display 138, to identify the software package to be installed, step 704. Part of this initial query could include identification of software package versions, software package modules, etc. Alternatively, this information could be retrieved as part of the setup procedure. Next, the processing unit 102 would use the identified software package to retrieve from, for example, memory 104 the executable file (saved in Step 616, FIG. 6) associated with the identified software package to be installed, step 706. The executable file could be stored locally, such as in RAM 108, on a hard disk associated with Hard Disk Drive 122, on a magnetic disk associated with magnetic disk drive 124, on an optical disk associated with optical disk drive 126, or remotely via network interface 134 or serial port interface 136. It may be beneficial to have some security protocols, such as encryption, associated with the application, especially if the application is retrieved from a remote source. Next, the processing unit 102 would execute the file that would begin displaying the questions previously designed to solicit the information for installing the software package, step 708. The user would answer the questions and the responses would be stored, typically in RAM 108, step 710. Based on the answer given, the next step would determine whether additional information is necessary, step 712. If additional information is necessary (identified by a link to a next question), control returns to step 708 to display the next question to the user. If additional information is not necessary (by for example no identified next question), the stored responses are complied and used to install the identified software package, step 714. Once the software package is installed, the process ends, step 716.

While the invention has been particularly shown and described with reference to some embodiments thereof, it will be understood by those skilled in the art that various other changes in the form and details may be made without departing from the spirit and scope of the invention.

We claim:

1. A method in a computer system for enabling the development of installation software, the method comprising the steps of:
generating at least one question definition screen;
entering at least one question on at least one generated question definition screen to solicit information from a user;
identifying at least one question answer type for the at least one entered question;
determining whether additional information is necessary to install the software;
if additional information is necessary, providing links to next questions to solicit additional information; and
if additional information is not necessary, storing the at least one entered question.

2. The method of claim 1, including encrypting the stored at least one entered question

3. The method of claim 1, including the step of:
saving the at least one question prior to a determination that additional information is not necessary.

4. The method of claim 1, including the step of:
providing links to help files, wherein such help files assist the user in providing at least one response.

5. The method of claim 4, further comprising the step of providing at least one default response for the at least one question.

6. The method of claim 4, including the step of:
emailing a question to a help reference.

7. An apparatus for enabling the development of installation software wizards, comprising:
at least one memory;
at least one executable file stored in the at least one memory;
the at least one executable file comprising at least one instruction for providing at least one question definition screen;
at least one monitor;
at least one processing unit capable of executing the at least one instruction to display the at least one question definition screen to at least one user on the at least one monitor;
at least one input device capable of receiving information regarding at least one question from the at least one user; and
a compiler to compile all the received information, wherein the received information is saved

8. The apparatus of claim 7, wherein the at least one memory, the at least one monitor, the at least one processing unit, the at least one input device, and compiler are coupled by at least one of a bus protocol, a wireless protocol, an intranet protocol, an extranet protocol, and html protocols.

9. The apparatus of claim 7, wherein the at least one memory comprises at least one help file.

10. The apparatus of claim 7, wherein the at least one processing unit includes a security module.

11. A computer program product comprising:
a computer usable medium having computer readable code embodied therein for processing data to develop installation software wizards, the computer usable medium comprising:
a question generation module configured to generate at least one question definition screen;
a receiving module configured to receive at least one question designed to solicit information from a user;
a determining module configured to determine whether additional information is need for the software installation;
a linking module configured to provide links to next questions if additional information is determined to be need; and
a saving module configured to save the at least one received question.

12. The computer program product of claim 11, comprising:
an encryption module configured to provided encryption.

13. The computer program product of claim 11, comprising:
a help module configured to provide help relating to the at least one question.

14. A method of installing software on a computer system, the method comprising the steps of
identifying at least one software package to be installed;
executing at least one installation application associated with the at least one identified software package to be installed,
displaying at least one question to solicit information from at least one user to install the software package,
storing the solicited information;
determining whether a next question exists based on the received solicited information;
displaying the next question if a next question exists; and
installing the at least one software package is a next question does not exist.

15. The method of claim 14, further comprising the step of:
providing help regarding the at least one question;

16. The method of claim 14, further comprising the step of:
saving the solicited information prior to installing the at least one software package.

17. A computer program product comprising:
a computer usable medium having computer readable code embodied therein for processing data to install software, the computer usable medium comprising:
an identifying module configured to identify at least one software package to be installed,
an executing module configured to execute at least one installation application associated with the at least one identified software package to be installed;
a displaying module configured to generate a display to solicit information from at least one user to install the software package;
a storing module configured to store the solicited information;
a determining module configured to determine whether additional information is to be solicited; and
an installation module configured to install the at least one software package when the determining module determines additional information is not to be solicited.

18. The computer program product of claim 17, further comprising:
a security module configured to provide encryption.

19. The computer program product of claim 17, further comprising:
a help module configured to provide help information relating to solicited information.

20. The computer program product of claim 17, further comprising:
a save module configured to save solicited information relating to the installation.
